(19) United States
(12) Patent Application Publication
(10) Pub. No.: US 2009/0161140 A1
(43) Pub. Date: Jun. 25, 2009

(54) USER INTERFACE FOR INTERACTIVE GRAPHICAL JOB RECOVERY

(75) Inventor: Nathan Devries, Webster, NY (US)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 11/961,169

(22) Filed: Dec. 20, 2007

(51) Int. Cl. G06F 15/00

(52) U.S. Cl. 358/1.14

(57) ABSTRACT

In response to a printing system fault or controller restart, a printing system print controller may present an interactive graphical job recovery user interface. The user interface may present one or more images that the print controller believes have printed successfully and/or a next page image scheduled to be sent by the print controller to the printing system print engine for printing. The user interface may allow a printing system operator to scroll forward and/or backward through the set of page images arranged in their respective print order until the user interface displays the correct page image that the print operator can confirm has printed correctly, based on an inspection of the print job. The print controller may resume the print job by sending to the print engine the page image from the stored image repository that follows the image confirmed by the printing system operator to have successfully printed.

### BACKGROUND

This disclosure generally relates to maintaining the integrity of a multi-page print job despite the occurrence of one or more processing, paper handling, printer and/or finishing device faults that abnormally interrupt production of the multi-page print job.

An important goal in production printing systems is to maintain job integrity, i.e., a print job should contain one and only one copy of each requested page. To maintain job integrity after a paper jam or other fault, the printer software maintains information on which pages in a print job have been completed, and which pages still remain to be printed. Following a jam, printing resumes with the last incomplete sheet. Such an approach works well as long as the printer's internal state accurately reflects the physical state of the machine. Occasionally, however, completed sheets must be remade because they were damaged as a result of the fault. For example, a page that the printer believes is completed may have been damaged as a result of a paper jam in the printer or a finishing device. Further, in some cases a page may be successfully printed even though the printing system believes that the page did not successfully complete the printing process. Currently in such cases, the operator is required to examine the job after the print job has finished, and manually remake any missing sheets and/or remove extra sheets.

One problem with manually remaking missing sheets is that such a manual process is tedious and error prone. An operator must remember to inspect the output for missing and/or extra sheets in places where faults occurred. Often, an operator will forget to perform such an inspection, or worse, the operator may not bother to perform the inspection. However, even if the operator does inspect the print output stack for missing sheets, there is a chance that the operator will not notice one or more missing and/or extra page sheets.

### SUMMARY

Hence, a need remains for an approach that allows a printing system operator to restore the integrity of a print job after a fault has occurred that interrupts execution of the print job. The approach should allow an operator to restore the integrity of a print job despite the nature of the fault that interrupted the print job and despite the type of printing system in use.

For example, one exemplary printing system may include a scanner, a print engine and one or more finishing devices that are directly controlled by a common printing system controller. Another exemplary printing system may include one or more of a scanner, a print engine and one or more finishing devices, all of which operate independently from a printing system controller. Yet another exemplary printing system may include one or more of a scanner, a print engine and one or more finishing devices, some of which are directly controlled by a common print controller, and some of which operate independently of the print controller. Still yet another exemplary printing system may not include a scanner, but may include one or more of a print engine and one or more finishing devices, some of which may be directly controlled by a common print controller, and some of which may operate independently of the print controller.

According to one exemplary embodiment of the described interactive graphical job recovery approach, a print controller may maintain an image repository that may contain a copy of page images within a print job, e.g., all page images in the print job, all page images in the print job up to a predetermined threshold limit, etc., that have been, or soon will be, submitted to a print engine for printing. Further, the print controller may maintain a stored parameter that identifies the last page image of the print job that the controller believes has printed successfully.

If the print controller receives a signal indicating that a fault has occurred during the execution of a print job, the print controller may halt, or interrupt, execution of the print job, In response to the print job interruption, the printing system operator may take action to Correct the cause of the fault. For example, the printing system operator may clear a print jam in the print engine or a finishing device, may add toner to the printer engine, etc. Once the cause of the fault has been corrected, a printing system operator may manually request, or the printing system print controller may automatically present, an interactive graphical job recovery user interface that may present a graphical image of the last print job page image the print controller believes successful printed and may present a graphical image of the next print job page image the print controller intends to submit to the print engine.

However, as a result of the fault, one or more pages that the print controller has recorded as having been printed successfully, may have been damaged, and therefore must be reprinted. Based on a review of the printed material produced by the printing system, the printing system operator may validate whether the interactive graphical job recovery user interface correctly displays the last image successfully generated. For example, if the interactive graphical job recovery user interface does not display the correct last image successfully printed, the printing system operator may scroll backward through the images presented until the interface correctly identifies the last image successfully printed.

Upon receiving a confirmation from the printing system operator that the page image displayed by the interactive graphical job recovery user interface as the last page successfully printed matches the last page observed by the printing system operator to have been successfully printed, the printing system may resume the print job. For example, the printing system print controller my resume the print job starting with the page image immediately after the last page successfully printed in the print job print order sequence.

According to a second exemplary embodiment if, during a multi-page print job, a fault were to occur in the print controller itself, the print controller may initiate a restart and may become temporarily unavailable. hi a printing system in which the print engine and the one or more finishing devices operate independently, despite the print controller being unavailable, the print engine may continue to print an image received from the print controller prior to the restart, and the finishing devices may properly process the printed page, so that any page images received from the print controller prior to the restart may be completed successfully.

Upon completion of the print controller restart, a printing system operator may manually request, or the print controller may automatically present, the interactive graphical job recovery user interface. However, because the print controller restarted before the last page submitted to the print engine was completed, the graphical job recovery user interface may indicate, as the last image to have completed printing, an image prior to the last image sent to the print engine before the print controller restart.

In such a situation, the printing system operator may scroll forward, through the set of images presented via the interactive graphical job recovery user interface, and may confirm that the interface correctly displays the last image successfully printed once the image indicated in interactive graphical job recovery user interface as the last page successfully output matches the last page observed by the printing system operator to have been successfully printed. Upon receiving a confirmation from a printing system operator via the interactive graphical job recovery user interface, the print controller may resume the print job by sending to the print engine the page image from the stored image repository that follows the image confirmed by the printing system operator to have successfully printed.

In the above examples, the interactive graphical job recovery user interface improves the integrity of the print job by providing the printing system operator with the information needed, at the time of the fault, to assure that the integrity of the print job is not compromised. In this manner the printing system operator may assure that the generated print job contains one, and only one, copy of each page intended for inclusion in the print job and avoids the need to verify and/or correct deficiencies once the print job is complete.

### BRIEF DESCRIPTION OF THE DRAWINGS

Exemplary embodiments will be described with reference to the accompanying drawings, wherein like numerals represent like parts, and in which:

FIG. 1 is a system level block diagram of an exemplary printing system that supports an interactive graphical job recovery user interface;

FIG. 2 is a module level block diagram of an exemplary image repository presented in FIG. 1;

FIGS. 3 is a module level block diagram of an exemplary job status tracking module presented in FIG. 1;

FIG. 4 is a module level block diagram of an exemplary job recovery module presented in FIG. 1;

FIG. 5 is a front plan view of an exemplary integrated-component printing system that supports an interactive graphical job recovery user interface;

FIG. 6 is a system level network diagram of an exemplary nonintegrated component printing system that supports an interactive graphical job recovery user interface;

FIG. 7 is an exemplary user interface that supports an interactive graphical job recovery user interface;

FIG. 8 is a flow diagram representing an exemplary method for controlling operation of a printing system that includes an integrated scanner and a print controller with an interactive graphical job recovery user interface; and

FIG. 9 is a flow diagram representing an exemplary method for controlling operation of a printing system with a print controller that includes an interactive graphical job recovery user interface that received page images from an external network source.

### DETAILED DESCRIPTION OF EMBODIMENTS

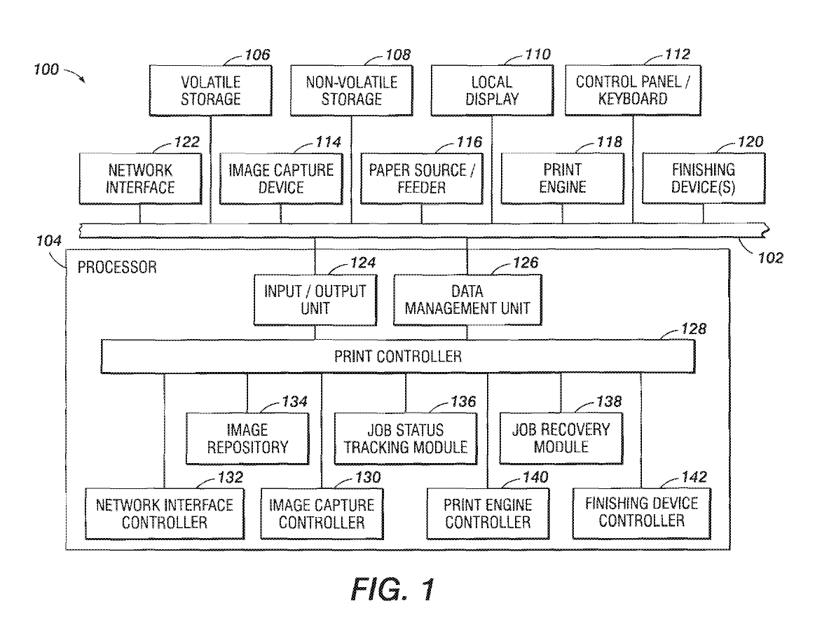

FIG. 1 is a system level block diagram of an exemplary printing system that supports an interactive graphical job recovery user interface. As shown in FIG. 1, a printing system 100 that supports an interactive graphical job recovery user interface may include a computer system data bus 102 that allows a processor 104 to communicate with, and exchange information with hardware components of the printing system such as: volatile memory storage 106, which allows the processor 104 to store program instructions in local memory for execution and to store and maintain temporary data necessary for execution of the stored program instructions; non-volatile storage 108, such as a hard-drive and/or firmware storage, which allows processor 104 to access and retrieve larger bodies of data and program instructions for later use/execution by the processor; local display 110, which may support a visual interface with a printing system operator; control panel/keyboard 112, and/or a cursor control device that allow the processor to receive user instructions and/or information and/or feedback; network interface 122 which allows processor 104 to communicate with and exchange information network connected processing devices, storage devices and/or independent printing system components; image capture device 114, which scans paper-based documents to be reproduced, thereby allowing printing system 100 to generate and store images of pages within a print job; paper source/feeder 116 which provides the printing system with paper upon which to transfer reproduction copies of scanned/received page images; print engine 118 which transfers visual copies of electronically stored images to paper; one or more finishing devices 120 that receive printed sheets from print engine 118 and process the received sheets, for example, by sorting, collating, folding, stapling, etc.;

As further shown in FIG. 1, processor 104 may include internal components that allow the processor to communicate with the above-described hardware components to send and to receive data and instructions over system bus 102. Such components may include: a print controller 128 capable of communicating with and controlling an input/output unit 124 that manages communication exchanges with the system bus 102; and a data management unit 126, which allows the print controller to maintain a local set of control parameters such as counters, pointers, and segments of executable program instructions for execution.

For example, when provided with executable instructions, print controller 128 may, in accordance with instructions/commands received from a user via control panel/keyboard 112 or via a network connection via network interface 122, retrieve and initiate control parameters/pointers for the execution of program instructions related to processing print jobs. For example, at startup, print controller 128 may retrieve and load program instructions from nonvolatile storage 108 into volatile/nonvolatile memory 106 for execution and may maintain control parameters in data management unit 126 for use in controlling the simultaneous and/or sequential execution of the program instructions retrieved for execution. For example, as shown in FIG. 1, processor 104 may establish, based on stored pro gram instructions retrieved for execution from nonvolatile storage 108: a print controller 128 that may control overall operation of the printing system and the production of hardcopy output based on original hardcopy and/or electronically stored images in accordance with operator provided print job control parameters; an image capture controller 130 that may control the creation of electronic page images from hardcopy images scanned by image capture device 114; a network interface controller 132 that may control the receipt of, for example, operator provided print job control parameters and/or electronic page images received over a network connection via network interface 122; an image repository 134 that may store electronic page images captured by image capture controller 138 and/,or received via network interface 122 for subsequent use; a job status tracking module 136 that may monitor the status of a pending job, for example, by recording the identity of the last several page images submitted from image repository 134 to print engine 118, and monitoring the print completion of each of submitted page image; a job recovery module 138 that may monitor the status of the printing system, for example, whether a fault or a restart has occurred, and initiates the described interactive graphical job recovery user interface with images retrieved from image repository 134 based on information obtained from job status tracking module 136; a print engine controller 140 that may control print engine 118 to execute print jobs in accordance with operator provided print job image sources and/or control parameters, e.g., number of copies, stock/paper selection, enlargement, reduction, etc.; and a finishing device controller 142 that may control operation of one or more finishing devices 120 to post process, e.g., fold, collate, staple, insert front/back cover inserters, bind, etc., in accordance with operator provided print job image sources and/or control parameters.

In operation, each of the above-described modules/controllers executed by processor 104 may maintain a work-flow state machine, and/or control parameters that allow the module to perform its assigned task. For example, print controller 128 may maintain a work-flow, state machine, and/or control parameters that allows print controller 128 to coordinate the functions performed by other modules/controllers executed by processor 104 to implement a print job. For example, print controller 128 may contain a set of master control parameters that allows it to initiate the performance of specific actions by each of the other modules/controllers executed by processor 104 in accordance with a print job work-flow dictated by the operator provided print job image sources and/or control parameters. Each module/controller executing an assigned task may provide print controller 128 with status updates, for example, indicating the completion of a task, indicating a fault that has occurred during execution of the assigned task, indicating the number of pages processed so far, etc., thereby allowing print controller 128 to orchestrate activities performed by the respective modules/controllers in series and/or in parallel to expedite the smooth and efficient execution of a print job.

For example, assuming that a print job relates to producing and finishing copies based on a hardcopy original placed in image capture device 114, print controller 128 may first initiate image capture controller 130 to initiate scanning and to store generated page images into image repository 134. During the scanning process, image capture controller 130 may control operation of image capture device 114, and may provide print controller 128 with high level status updates, e.g., scan initiated, scan completed, fault/type of fault detected, that allow print controller 128 to coordinate execution of other modules/controllers that may be called on to support the print job. Further, image repository 134 may control operation of designated portions of volatile memory 106 and/or non-volatile storage 108 to store images in a preconfigured catalog/file format, and may provide print controller 128 with high level status updates, e.g., number of pages stored in association with a print job, fault/type of fault detected, etc., that allow print controller 128 to coordinate execution of other modules/controllers that maybe called on to support the print job.

Once print controller 128 determines that a sufficient number of page images have been stored in image repository 134, print controller 128 may initiate print engine controller 140 to initiate, e.g., in parallel or in series with the scanning process, printing of hardcopy reproduction pages based on the stored images in accordance with operator provided print job control parameters. Print engine controller 140 may retrieve images from image repository 134 and may control operation of print engine 11 8 to generate printed hardcopy based on the retrieved images and to pass each generated hardcopy page to the first of one or more finishing devices as each page is printed. During the printing process, print engine controller 140 provide print controller 128 with high level status updates, e.g., number of pages printed, last page image retrieved from image repository 134, the last page that completed printing, fault/type of fault detected, etc., that allow print controller 128 to coordinate execution of other modules/controllers that may be called on to support the print job.

If finishing services have been requested, print controller 128 may initiate finishing device controller 142 to process printed pages received from print engine 118 in accordance with operator provided print job control parameters. During the finishing process, finishing device controller 142 may provide print controller 128 with high level status updates, e.g., number of pages processed, number of finished packages completed, fault/type of fault detected, etc., that allow print controller 128 to coordinate execution of other modules/controllers that may be called on to support the print job.

Throughout a print job process, job status tracking module 136 may store information on the status of the print job. Such information may be received directly from the respective modules/controllers, e.g., image capture controller 130, print engine controller 140, finishing controller 142, etc., or from print controller 12′8. For example, the job status information maintained by job status tracking module 136 may include, but is not limited to, a list identifying each image submitted to print engine 118 by print engine controller 140, including an identifier of the last page image submitted to print engine 118. Such information may be passed to job recovery module 138 in the event of a fault within printing system 100 that results in an interruption of a print job, e.g., such as a paper jam in paper source/feeder 116, print engine 118 or finishing devices 120. Job status tracking module 136 may also pass such status information to job recovery module 138 following a restart of processor 104. Job recovery module 138 may use such status information to control presentation of an interactive graphical job recovery user interface as described in greater detail below.

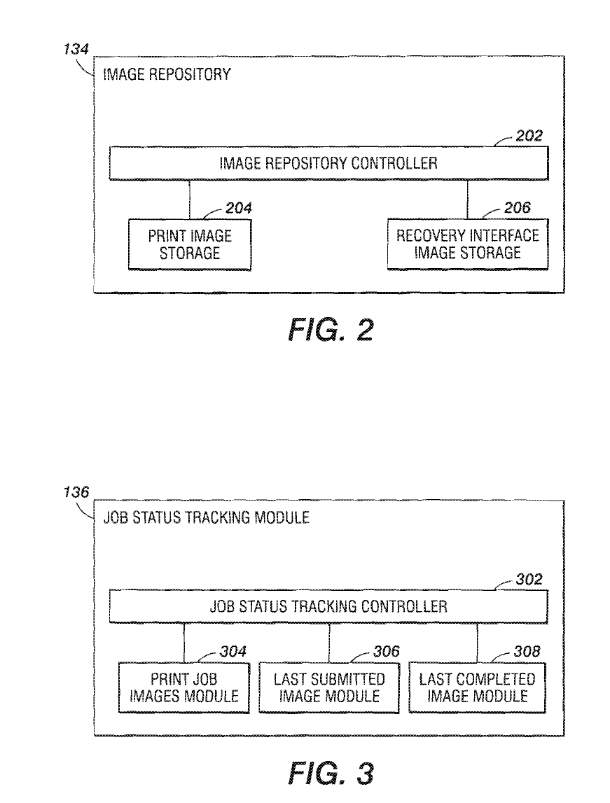

FIG. 2 is a module level block diagram of an exemplary image repository 134 described above with respect to FIG. 1. As shown in FIG. 2, image repository 134 may include an image repository controller 202, print image storage 204 and recovery interface image storage 206. Image repository 134 may receive and store print job images that are generated, for example, by image capture device 114 under the control of image capture controller 130. Image repository 134 may also receive and store print job images that are received from an external print image source received in association with a remotely initiated print job, for example, over network interface 122 under the control of network interface controller 132. Such network connected print image sources may include end-user applications such as, for example, word processors, photograph editors and,/or desktop publishing applications that are authorized to send generated print images to print system 100 for printing and finishing.

In one exemplary embodiment, image repository 134 may be instructed by print controller 128, via communication between print controller 128 and image repository controller 202, to receive print images from an identified source, e.g., network interface 12 or image capture device 114, in association with an identified print job. In response, image repository controller 202 may store information related to the print job and begin storing the received print images in print image storage 204. In addition, image repository controller 20(2 may generate a lower resolution version of each stored print image for possible future use by job recovery module 138 within the interactive graphical job recovery user interface, as described in greater detail below. The lower resolution images may be stored by image repository controller 202 in recovery interface image storage 206. Both print image storage 204 and recovery interface image storage 206 may, for example, use physical storage space provided by one or more of volatile storage 106 and non-volatile storage 108, as needed, based on such considerations as, for example, the volume of storage required, the speed with which the images need to be saved and/or the speed with which the images need to be retrieved to support the efficient operation of the print job and/,or the interactive graphical job recovery user interface.

FIG. 3 is a module level block diagram of an exemplary job status tracking module 136 described above with respect to FIG. 1. As shown in FIG. 3, job status tracking module 136 may include a job status tracking controller 302, print job images module 304, last submitted image module 306 and last completed image module 308. In operation, job status tracking controller 302 may communicate with, for example, print controller 128, image repository 134 and/or print engine controller 140, to track the operational status of a pending print job. For example, identifiers for print job print images stored in print job images module 304 may be stored in a print job print sequence order based on the order that respective images are received by image repository 134. The identifier for the print job print image stored in last submitted image module 306 may be based on communication with print engine controller 140 to store the identifier of the last page image submitted by print engine controller 140 to print engine 118. The identifier for the print job print image stored in last completed image module 308 may be based on communication with print engine controller 140 to store the identifier of the last page image reported by print engine 118 as having been successfully printed. Identifiers for print job print images, the last submitted page image and the last completed image identifier information may be provided by job status tracking controller 302 to job recovery module 138, as needed, to support operation of the interactive graphical job recovery user interface, as described below.

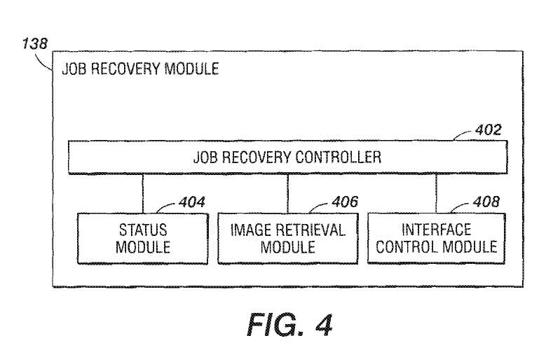

FIG. 4 is a module level block diagram of an exemplary job recovery module 138 described above with respect to FIG. 1. As shown in FIG. 4, job recovery module 138 may include job recovery controller 402, status module 404, image retrieval module 406 and interface control module 408. A role of job recovery module 138 may be to support presentation of an interactive graphical job recovery user interface that may be presented to a user following a printing system fault that causes execution of a print job to be temporarily halted, e.g., due to a paper jam or other malfunction such as a printing system processor restart.

In operation, an exemplary job recovery module 138 may be invoked by print controller 128, following a restart of processor 104 or in response to detection by print controller 128 of a printing system fault that results in a current print job being temporarily halted. Upon being invoked job recovery controller 402 may communicate, via status module 404, with job status tracking controller 302 to obtain identifiers for page images associated with the interrupted print job.

For example, status module 404 may communicate with job status tracking controller 302 to obtain, for example, a listing of identifiers for page images submitted to print engine 118, an identifier for the last image submitted to print engine 118 and an identifier for the last page image completed by print engine 118. As described above, such information may be obtained by job status tracking controller 302 from print job images module 304, last submitted image module 306 and last completed image module 308, respectively. The status information collected by status module 404 by job recovery controller may be stored in status module 404.

Once the interrupted print job page image identifiers have been obtained, job recovery controller 402 may invoke image retrieval module 406 to obtain the identified images from image repository 134. For example, image retrieval module 402 may request, via communication with image repository controller 402, either copies of the actual print images stored in print image repository 204, or reduced resolution copies of the print images stored in recovery interface image storage 206.

As described above, the print status information retrieved by status module 404 from job status tracking module 136 represents the best information available to print controller 128 regarding the physical status of an interrupted print job. However, due to the nature of a fault, certain pages indicated as having been completed by actual be damaged beyond use and must be reprinted. Further, if the fault was a restart of processor 104 and the printing system print engine 118 is capable of independent operation, pages submitted to the print engine may actually have been completed, but not indicated as completed in the information maintained by job status tracking module 136.

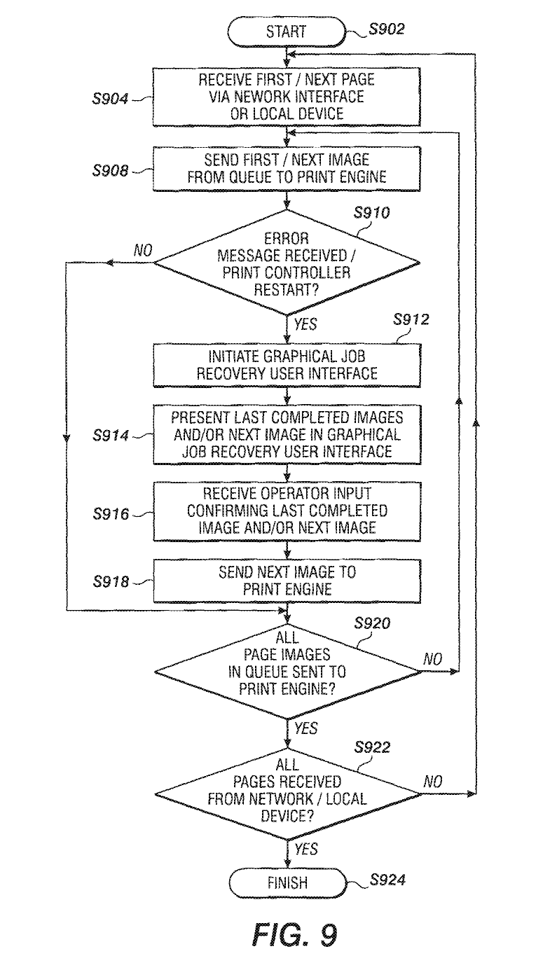

Therefore, once the request status information and images have been retrieved, job recovery controller 402 may invoke interface control module 408 to present the printing system operator with an interactive graphical job recovery user interface, for example, as described below with respect to FIG. 9. An exemplary interactive graphical job recovery user interface may present the printing system operator with a display that includes an image of the last page image that the print controller believes was successfully printed, and may present an image of the next page image to be submitted to the print engine for printing once the print job is resumed. The interface may allow the printing system operator to scroll forward and/or scroll backward through page images presented in the same order as the print job. The printing system operator may scroll forward and/or backward through the set of images presented via the interactive graphical job recovery user interface until the page image displayed as the last page successfully printed corresponds with the last page observed by the printing system operator to have been successfully printed. The printing system operator may then confirm, via the user interface, that the image indicated in the interactive graphical job recovery user interface as the last page successfully output matches the last page observed by the printing system operator to have been successfully printed. Upon receiving a conformation from a printing system operator via the interactive graphical job recovery user interface, the print controller may resume the print job by instructing print engine controller 140 to resume printing from the stored image repository that follows the image confirmed by the printing system operator to have successfully printed.

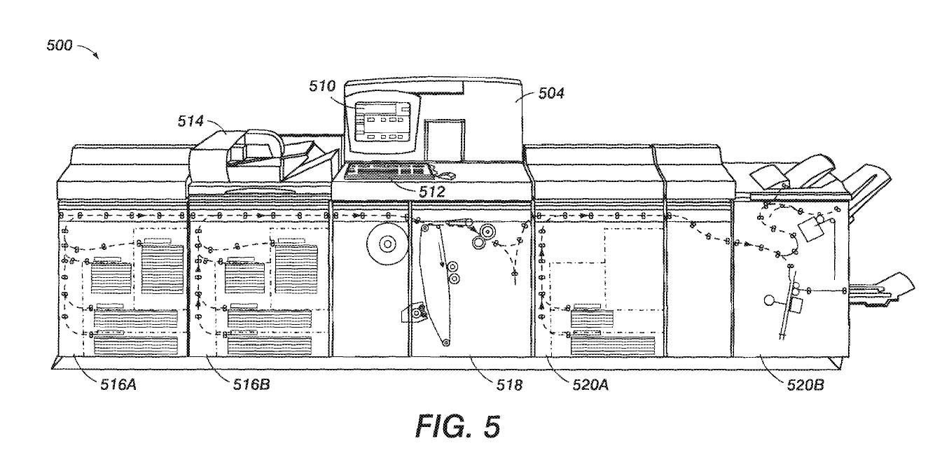

FIG. 5 is a front plan view of an exemplary integrated-component printing system that supports an interactive graphical job recovery user interface for use in restarting interrupted print job as a result of printing system faults, as described above. Printing system 500 may be called an integrated-component printing system because the respective components are included within modular units that may be electrically and mechanically connected into a common physical unit.

As shown in FIG. 5, printing system 5001 may include all the components described above with respect to printing system 100 described above with respect to FIG. 1. For example, as shown in FIG. 5, printing system 500 may include: a local processing Unlit 504 that may contain a processor and related circuitry necessary to execute firmware and/or software base executable programs for monitoring and controlling operation of printing system 500; a local display 510, which may support a visual interface between processing unit 504 and a printing system operator; a control panel/keyboard 512, and/or a cursor control device that may allow processing unit 504 to receive user instructions and/or information and/or feedback; an image capture device 514 that may scan paper-based documents to be reproduced, thereby allowing printing system 500 to generate and store electronic images of pages within a print job; one or more paper sources/feeders 516 that may provide the printing system with sources of various stock upon which to transfer reproduction copies of scanned/received page images; a print engine 518 that may transfer visual copies of electronically stored images to paper; and one or more finishing devices 520 that receive printed sheets from print engine 518 and process the received sheets, for example, by sorting, collating, folding, stapling, etc. Printing system 500 may also include a network interface, not shown, that may allow printing system 500 to execute print jobs based on electronic page images received over a network. Further, local processing unit 504 of printing system 500 may be configured to with the firmware/software modules, described above with respect to FIG. 1, that support presentation of an interactive graphical job recovery user interface with a printing system operator via a local display 510 and control panel/keyboard 512.

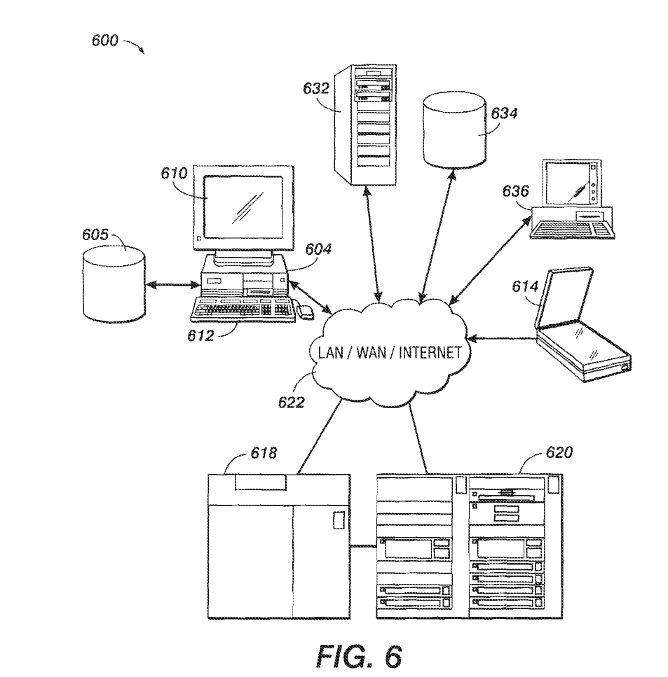

FIG. 6 is a system level network diagram of an exemplary non-integrated component printing system 600 that supports an interactive graphical job recovery user interface for use in restarting interrupted print job as a result of printing system faults, as described above. Printing system 600 may be called a non-integrated component printing system because the one or more components may be physically separate from the other components forming the printing system.

As shown in FIG. 6, printing system 600 may include a network 622 that may include one or more of a local area network (LAN) segment, a wide area network (WAN) segment and/or an Internet segment to provide connectivity between the respective components of the printing system 600. For example, as shown in FIG. 6, components forming printing system 600 may be interconnected by network 622. For example, one component connected via network 622 to form printing system 600 may be processing unit 604 that may include: processor unit 604 and related circuitry necessary to execute firmware and/or software base executable programs for monitoring and controlling operation of printing system 600; a local display 610 connected to processing unit 604 that may support a visual interface between processing unit 604 and a printing system operator; a control panel/keyboard 612; and a local storage device 605 that may be used to store page images prior to transmission of the pages images across network 622 to print engine 618. Other component connected via network 622 to form printing system 600 may include networked removable storage media device 632, data storage device 634, computer workstation 636, scanner 614, and printer engine 618 with one or more finishing devices 620.

Although many of the components are connected to each other only by network 622, printing system 600 may operate in very much the same manner as that described above with respect to printing system 500. For example, the interactive graphical job recovery user interface described above with respect to FIG. 1 through FIG. 5, may also operate in the same manner, with the exception that fault notifications sent between printer system components via may be sent between the respective components via network 622 rather than over computer system data bus 102 common only to the respective printing system components.

In printing system 600, however, print job page images may originate from any device connected to the network. For example, page images originating from any of network connected removable storage media device 632, network connected data storage device 634, computer workstation 636 and network connected scanner 614 may be transferred to processing unit 604 for storage within image repository 134 for subsequent processing as a print job, and may be submitted by processing unit 604 to printer engine 618 and one or more finishing devices 620, resulting in a printed product. So long as a local printing system operator is able to review the hardcopy pages produced by printer engine 618 and one or more finishing devices 620 and has access to processing unit 604, the above-described interactive graphical job recovery user interface may operated in the same manner as described above with respect to FIG. 1 through FIG. 5.

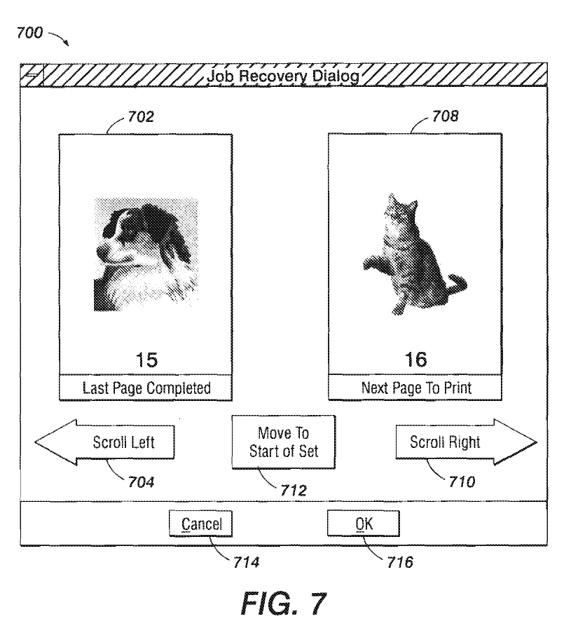

FIG. 7 is a screen capture of an exemplary display supported by an exemplary interactive graphical job recover, user interface. As shown in FIG. 7, graphical job recovery user interface 700 may include a view of a last page completed window 702, a scroll left button 704, a view of next page to print window 708, a scroll right button 710, a move to start of set button 712, a CANCEL button 714, and an OK button 716.

As described above with respect to FIG. 1 through FIG. 4, following a print controller restart and/or other fault that has interrupted an executing print job, job recovery module 138 may be invoked, either automatically, or by print controller 128. Job recovery module 138 may retrieve page images associated with the interrupted print job from image repository 134 based on status information maintained by job status tracking module 136. The status information may include a set of page identifiers for page images within the print job, an identifier of the last page image sent to the print engine for printing, and an identifier for the last page indicated as having been printed/finished successfully. Once the status information, e.g., page image identifiers, etc., and related page images have been retrieved, job recovery module 138 may present on a local display 110 of printing system 100, e.g., via job recovery controller 402 and interface control module 408, an interactive graphical job recovery user interface 700 as shown in FIG. 7.

Interface control module 408 may initially present in last page completed window 702 a copy of the page image identified by job status tracking module 136 as being the last page image completed prior to the print job fault. Further, interface control module 408 may initially present in next page to print window 708 a copy of the page image immediately following the last page image printed, based on the sequence order of print job page image identifiers retrieved by job recovery module 138 from print job images module 304 of job status tracking module 136.

Based on a review of the printed material in the output trays of printing system 100, a printing; system operator may visually confirm whether last page completed window 702 correctly displays the last image successfully printed. If last page completed window 702 does not display the correct last image printed successfully, the printing system operator may scroll backward, or left, through the set of images presented via the interactive graphical job recovery user interface by selecting scroll left button 704. Each time scroll left button 704 is selected, last page completed window 702 and next page to print window 708 may be updated to reflect a shift backward of one page in the print image sequence of the print job.

For example, each time scroll left button 704 is selected, the page image shown in last page completed window 702 may be moved to next page to print window 708 and a new page image may be displayed in last page completed window 702 based on the print image sequence of the print job. If, on inspection, print images recorded by job status tracking module 136 as having successfully printed must be discarded, the printing system operator may select scroll left button 704 multiple times until the page image displayed in last page completed window 702 matches the last page observed by the printing system operator to have been successfully printed.

Further, each time scroll right button 710 is selected, the page image shown in next page to print window 708 may be moved to last page completed window 702 and a new page image may be displayed in next page to print window 708 based on the print image sequence of the print job. For example, if the printing system operator determines that more page images printed successfully than are indicated by last page completed window 702 and next page to print window 708, the printing system operator may select scroll right button 710 multiple times until the page image displayed in last page completed window 702 matches the last page observed by the printing system operator to have been successfully printed.

If the printing system operator determines, after inspecting the printed output, that all the pages in a current set of pages must be discarded, the printing system operator may select move to start of set button 712 to begin printing at the first page of the set. For example, if move to start of set button 712 is selected, last page completed window 702 may be updated to show a default message such as “Not Applicable,” and next page to print window 708 may be updated to display the first page of the set of pages to be reprinted.

Once the printing system operator determines that last page completed window 702 matches the last page observed by the printing system operator to have been successfully printed, and/or that next page to print window 708 displays the appropriate next page to print, the printing system operator may select OK button 716 to submit, for example, to the print controller 128 of printing system 100, any changes made by the printing system operator to the last page image completed and next page image to print, and the printing system will resume operation based on the newly determined status information. By selecting CANCEL button 714, the print operator may cancel any changes made by the printing system operator to the last page image completed and next page image to print, and the printing system will resume operation based on the originally determined status information.

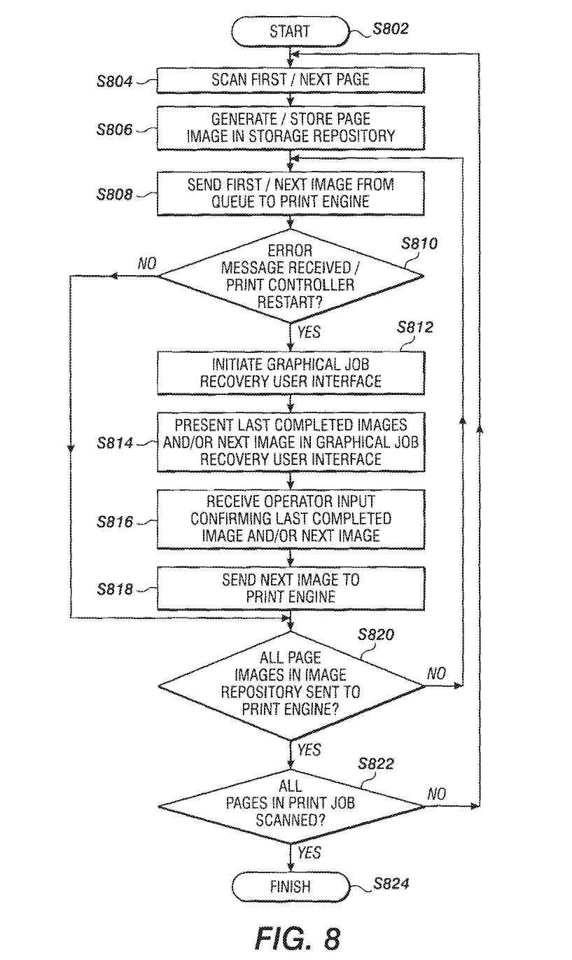

FIG. 8 is a flow diagram representing an exemplary method for controlling operation of a printing system executing a print job based on hardcopy images, the printing system including an interactive graphical job recovery user interface 700, as addressed above.

As shown in FIG. 8, the described process begins at step S802 and proceeds to step S804.

In step S804, a first/next hardcopy page image may be scanned, and operation of the method continues to step S806.

In step S806, an electronic page image, page image identifier, and a lower resolution version of the electronic page image may be generated, based on the scan of the hardcopy page image, and stored in image repository 134, and operation of the method continues to step S808.

In step S808, the print engine controller 128 may send a first/next image from image repository 134 to the printing system print engine 118, and operation of the method continues to step S810.

If, in step S810, print controller 128 receives indication of a fault that requires interruption of the current print job, or print controller 128 recovers from a restart, operation of the method jumps to step S812, otherwise operation of the method jumps to step S820.

In step S812, the interactive graphical job recovery user interface is initiated based on print job page image sequence information and last page completed information retrieved from job status tracking module 136, and operation of the method jumps to step S814.

In step S814, the last page completed page image and next page to be printed page image may be displayed via the interactive graphical job recovery user interface, and operation of the method jumps to step S816.

In step S816, input from a printing system operator maybe received confirming that the last page completed and next page to print images displayed via the interactive graphical job recovery user interface accurately reflect the status of the print, and operation of the method jumps to step S818.

In step S818, a next page image is sent to the printing system print engine corresponding to next page to print image displayed via the interactive graphical job recovery user interface, and operation of the method jumps to step S820.

If, in step S820, the printing system print controller determines that all print age images stored in the image repository have been sent to the print engine, operation of the method jumps to step S822, otherwise, operation of the method returns to step S808.

If, in step S822, the printing system print controller determines that all print job hardcopy pages have been scanned, operation of the method jumps to step S824 and the print job process terminates, otherwise, operation of the method returns to step S804.

FIG. 9 is a flow diagram representing an exemplary method for controlling operation of a printing system executing a print job based electronic page images received via a network connection from a network connected device, e.g., such as a computer workstation executing a desktop publishing system or a remote removable media storage device, the printing system including an interactive graphical job recovery user interface 700, as addressed above.

As shown in FIG. 9, the described process begins at step S902 and proceeds to step S904.

In step S904, the printing system receives one or more print job page images and stores the one or more print job page images in image repository 134, and operation of the method continues to step S908.

In step S908, print engine controller 140 for the printing system may send a first/next image from the image repository 134 to the printing system print engine 118, and operation of the method continues to step S890.

If in step S910, print controller 128 receives indication of a fault that requires interruption of the current print job, or print controller 128 recovers from a restart, operation of the method jumps to step S912, otherwise operation of the method jumps to step S920.

In step S912, the interactive graphical job recovery user interface is initiated based on print job page image sequence information and last page completed information retrieved from job status tracking module 136, and operation of the method jumps to step S914.

In step S914, the last page completed page image and next page to be printed page image may be displayed via the interactive graphical job recovery user interface, and operation of the method jumps to step S916.

In step S916, input from a printing system operator may be received confirming that the last page completed and next page to print images displayed via the interactive graphical job recovery user interface accurately reflect the status of the print, and operation of the method jumps to step S918.

In step S918, a next page image is sent to the printing system print engine corresponding to next page to print image displayed via the interactive graphical job recovery user interface, and operation of the method jumps to step S920.

If, in step S920, the printing system print controller determines that ail print age images stored in the image repository have been sent to the print engine, operation of the method jumps to step S922, otherwise, operation of the method returns to step S908.

If, in step S922, the printing system print controller determines that all print job page images have been received, operation of the method jumps to step S924 and the print job process terminates, otherwise, operation of the method returns to step S904.

It is to be understood that the various functions that support the described interactive graphical job recovery user interface may be distributed in any manner among any quantity (e.g., one or more) of hardware and/or software modules or units that may be interconnected with circuitry and/or software interfaces.

The functions that support the described interactive graphical job recovery user interface may include any commercially available operating system (e.g., Windows, OS/2, Unix, Linux, DOS, etc.), any commercially available and/or custom software (e.g., communication software, etc.) and any types of input/output devices (e.g., keyboard, mouse, probes, I/O port, etc.).

Software, or firmware, that support the described interactive graphical job recovery user interface may be implemented in any desired computer language, and may be developed by one of ordinary skill in the computer and/or programming arts based on the functional description contained herein and illustrated in the drawings. For example, in one example of an embodiment the described device may be written using the C++ programming language or the JAVA programming language. However, the present invention is not limited to being implemented in any specific programming language or combination of programming languages.

Any software associated with the described interactive graphical job recovery user interface may be distributed via any suitable media (e.g., removable memory cards, CD-ROM, tape or other storage media diskette, ad-hoc network connection). Software and/or default control parameters may be installed in any mariner (e.g., an install program, copying files, entering an execute command, etc.).

The described interactive graphical job recovery user interface may accommodate any quantity and any type of data sets in any desired format (e.g., ASCII, plain text, or other format, etc.). The format and structure of internal information structures used to hold intermediate information in support of the described interactive graphical job recovery user interface may include, but are not limited to files, arrays, matrices, status and control booleans/variables.

Further, any references herein to software performing various functions generally refer to computer systems or processors performing those functions under software control. The computer system may alternatively be implemented by hardware or other processing circuitry.

From the foregoing description, it will be appreciated that an approach for a printing system interactive graphical job recovery user interface is disclosed. The described approach improves the integrity of the print job of an interrupted print job by providing the printing system operator with the information needed, at the time of a printing fault, to assure that the integrity of the print job is not compromised.

For purposes of explanation, in the above description, numerous specific details are set forth in order to provide a thorough understanding of the described printing system interactive graphical job recovery user interface. it will be apparent, however, to one skilled in the art that the described interactive graphical job recovery user interface may be practiced without these specific details. In other instances, well-known structures and devices are shown in block diagram form in order to avoid obscuring the features of the described interactive graphical job recover, user interface.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for recovering from a failure during execution of a print job that includes a plurality of images, the method comprising:
determining that a print job failure has occurred;
displaying, via a user interface, one or more of the plurality of images sent to a print engine prior to the failure;
receiving input, via a user interface, identifying one of the displayed images; and
resuming execution of the print job based on the received input.

2. The method of claim 1, wherein determining that a print job failure has occurred further comprises:
receiving an error signal indicating that a print failure has occurred.

3. The method of claim 1, further comprising:
suspending execution of the print job on determining that a print failure has occurred.

4. The method of claim 1, wherein the failure is a failure of the print engine designated to print the plurality of images.

5. The method of claim 1, wherein the failure is a failure of a finishing device that processes one or more of the plurality of images after one or more of plurality of images has been printed.

6. The method of claim l, wherein the failure is a failure of a print controller that monitors and controls execution of the print job by one or more of a print engine and a finishing device.

7. The method of claim 1, wherein the one or more images displayed via the user interface includes one of an image of a last page printed successfully and an image of a next page to be printed.

8. The method of claim 1, wherein the input received via the user interface is a confirmation by a printing system operator of one of the displayed last page printed successfully and the displayed next page to print.

9. A printing system, comprising:
a print engine that receives and prints each of a plurality of images in a print sequence;
a controller that submits each of the plurality of images in the print sequence to the print engine, the controller comprising:
an image repository that stores each of the plurality of images in the print sequence sent to the print engine;
a status unit that maintains a print status of the plurality of images in the print sequence sent to the print engine and that determines that a print failure has occurred; and
a recovery unit that displays, via a user interface, one or more of the plurality of images sent to the print engine prior to the failure and that receives, via the user interface, input identifying one of the displayed images,
wherein the controller resumes sending images in the print sequence to the print engine based on the received input.

10. The system of claim 9, further comprising:
a finishing device that processes one or more of the plurality of images in the print sequence after one or more of plurality of images has been printed.

11. The system of claim 9, further comprising:
a network that provides communication connectivity between one or more of the print engine, the finishing device and the controller.

12. The system of claim 9, wherein the status unit determines that the print job failure has occurred based on a received error signal indicating that a print failure has occurred.

13. The system of claim 9, wherein the controller suspends execution of the print job on determining that a print failure has occurred.

14. The system of claim 9, wherein the failure is one of:
a failure of the print engine;
a failure of the finishing device; and
a failure of the controller that necessitates a restart of the controller.

15. The system of claim 9, wherein the one or more images displayed via the user interface includes one of an image of a last page printed successfully and an image of a next page to be printed.

16. The system of claim 9, wherein the input received via the user interface is a confirmation by a printing system operator of one of the displayed last page printed successfully and the displayed next page to print.

17. An image forming device comprising the system of claim 9.

18. A xerographic image forming device comprising the system of claim 9.

19. A computer readable medium including instructions executable by a computer for recovering from a failure during execution of a print job that includes a plurality of images, comprising:
instructions for determining that a print job failure has occurred, instructions for displaying, via a user interface, one or more of the plurality of images sent to a print engine prior to the failure;
instructions for receiving input, via a user interface, identifying one of the displayed images; and
instructions for resuming execution of the print job based on the received input.

20. The computer readable medium of claim 19, wherein the instructions for receiving input further include:
instructions for receiving, via the user interface, a confirmation by a printing system operator of one of a displayed last page printed successfully and a displayed next page to print.
